(19) United States
(12) Patent Application Publication
(10) Pub. No.: US 2014/0127393 A1
(43) Pub. Date: May 8, 2014

(54) METHOD OF APPLYING DENTURE ADHESIVES

(71) Applicant: DAVID G. HALL, OVERLAND PARK, KS (US)

(72) Inventor: DAVID G. HALL, OVERLAND PARK, KS (US)

(21) Appl. No.: 14/065,881

(22) Filed: Oct. 29, 2013

Related U.S. Application Data
(60) Provisional application No. 61/719,603, filed on Oct. 29, 2012.

(51) Int. Cl. A61C 13/225

(52) U.S. Cl. CPC A61C 13/225
USPC 427/2.29; 118/300

(57) ABSTRACT

A method of improving and extending the gripping action of denture by applying an adhesive compound includes applying a liquid denture adhesive to one or more locations on the dentures; wetting the dentures with water; and applying a powder denture adhesive onto at least the liquid denture adhesive in an amount about equal to an amount of the liquid denture adhesive to form the adhesive compound on the dentures in a semi-liquid form sufficient to enhance a gripping effect of the dentures in a mouth of a user.

### CROSS-REFERENCE TO RELATED APPLICATIONS

This application is related to and claims priority from U.S. Provisional Patent Application Ser. No. 61/719,603 filed on Oct. 29, 2012.

### FIELD OF THE INVENTION

The present invention relates, in general, to application of adhesives to dentures and, more particularly, this invention relates to methods of combining two or more adhesives to produce an adhesive compound for enhanced gripping.

### STATEMENT REGARDING FEDERALLY SPONSORED RESEARCH AND DEVELOPMENT

N/A

### REFERENCE TO SEQUENCE LISTING, A TABLE, OR A COMPUTER PROGRAM LISTING COMPACT DISC APPENDIX

N/A

### BACKGROUND OF THE INVENTION

As is generally well known, denture adhesives have been in use for many decades to help denture wearers maintain their dentures comfortably in position without coming loose during the course of eating or other activities. Conventional denture adhesives have a holding power of about twelve (12) hours. Formulations for such are widely available in the literature, such as that in U.S. Pat. No. 4,664,630. At least two Patent Application Publications have proposed methods for applying denture adhesives. Smetana et al in US 2007/0196787 discloses a simple additional wetting step, and Aleynik in US 2009/0068615 teaches a relatively complicated technique involving cutting paper liners. Neither offers anything similar to the present invention. Therefore, there is a need for an improved apparatus.

### SUMMARY OF THE INVENTION

The present invention provides a method of applying denture adhesive so as to enhance the grip, and includes steps of applying a liquid denture adhesive to one or more locations on the dentures; wetting the dentures with water; applying a powder denture adhesive onto at least the liquid denture adhesive in an amount about equal to an amount of the liquid denture adhesive to form the adhesive compound on the dentures in a semi-liquid form sufficient to enhance a gripping effect of the dentures in a mouth of a user. Optionally, the method may employ a device to facilitate the process, wherein the device is a dual-tube applicator.

### OBJECTS OF THE INVENTION

It is, therefore, one of the primary objects of the present invention to provide a method of improving and extending the gripping action of denture by applying an adhesive compound. The method includes applying a liquid denture adhesive to one or more locations on the dentures; wetting the dentures with water; and applying a powder denture adhesive onto at least the liquid denture adhesive in an amount about equal to an amount of the liquid denture adhesive to form the adhesive compound on the dentures in a semi-liquid form sufficient to enhance a gripping effect of the dentures in a mouth of a user.

Another object of the present method provides a method of improving and extending the gripping action of dentures by applying an adhesive compound, wherein a preselected quantity of liquid denture adhesive applied to the denture may have a diameter of about ⅛ inch to about ¼ inch. Particularly, the diameter of the applied liquid denture adhesive may be 3/16 inch in diameter.

Yet another object of the present method provides a method of improving and extending the gripping action of denture by applying an adhesive compound, wherein a preselected quantity of powder denture adhesive applied to the denture may have a diameter of about ⅛ inch to about ¼ inch. Particularly, the diameter of the applied powder denture adhesive may be 3/16 inch in diameter.

Another object of the present invention is to provide a method for applying denture adhesive with a device to enhance gripping of dentures to a user. The method comprises cleaning the dentures; drying the dentures; applying a first preselected quantity of a liquid denture adhesive to preselected locations on the dentures using the device; wetting the dentures with water; applying a second preselected quantity of powder denture adhesive onto the denture adhesive as well as on surrounding areas of the dentures using the device, wherein the second preselected quantity of powder denture adhesive is about equal to the first preselected quantity of denture adhesive; and pressing the dentures into position in a mouth of the user.

Still another object of the present invention is to provide a device for facilitating the application of a combination of adhesives to dental appliances according to the present method. The device includes a dual-tube applicator, including a first tube containing the liquid denture adhesive, markings on the first tube to aid in measuring dispensing the liquid denture adhesive, a mechanism for applying the liquid denture adhesive onto dentures, a second tube containing the powder denture adhesive, a cap covering one end of the second tube, markings on the second tube to aid in measuring dispensing the powder denture adhesive, and a manually operable discharge device operatively mounted in an opposite end of the second tube; whereby the device is configured to apply the liquid denture adhesive and the powder denture adhesive in an amounts about equal to each other and to form the adhesive compound in a semi-liquid form. The first tube may include a mechanism for pushing out and applying measured amounts of liquid onto the dentures. In one embodiment the mechanism for applying the liquid onto the dentures is a syringe. In one embodiment, the discharge device of the second tube may be a star valve.

A further object of the present invention is to provide an application device for applying a denture adhesive compound to enhance gripping of dentures to a user including a first device configured to hold liquid denture adhesive and a second device configured to hold powder denture adhesive. The first device and the second device are configured to apply equal amounts of liquid denture adhesive and powder denture adhesive to preselected locations on said dentures to form the adhesive compound on the dentures in a semi-liquid form sufficient to enhance a gripping effect of the dentures in a mouth of a user. The first device may comprise a first tube containing the liquid denture adhesive, markings on the first tube to aid in dispensing the liquid denture adhesive, and a mechanism for applying the liquid denture adhesive onto dentures. The first device may be a syringe or a squeezable tube. Additionally, the first device may be configured to hold a single application of liquid denture adhesive. The single application may be a preselected quantity. The second device may include a tube containing said powder denture adhesive, a cap covering one end of said second tube, markings on said second tube to aid in dispensing said powder denture adhesive, and a manually operable discharge device operatively mounted in an opposite end of said second tube. The manually operable discharge device may be a star valve. The second device may be a jar. The second device may be configured to hold a single application of powder denture adhesive. The single application may be a preselected quantity.

Yet another object of the present invention is to provide an improved method for ensuring that dentures remain in place for an extended period.

An additional object of the present invention is to provide a method of applying denture adhesive so as to enhance the gripping action.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 is a flow diagram of an exemplary method for applying denture adhesives to oral dentures so as to enhance the grip; and

FIG. 2 presents an elevation view of an optional device for facilitating the method of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components, which have identical functions, have been identified with identical reference numerals throughout the several views illustrated in the drawing figures.

It is to be understood that the definition of a denture adhesive applies to a material used to adhere a denture to the oral mucosa.

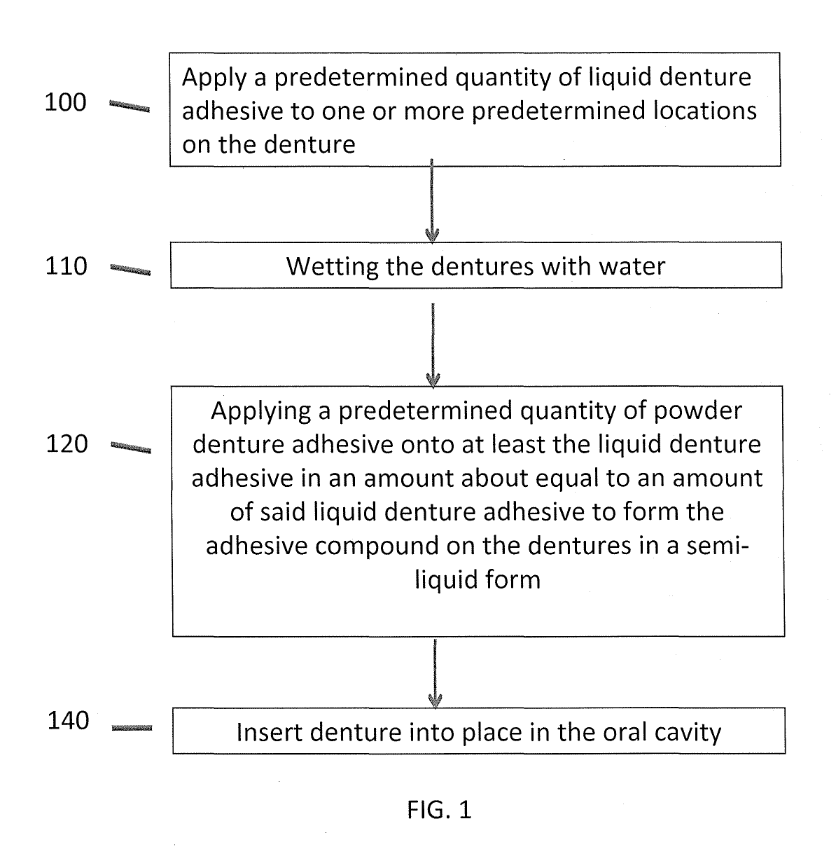

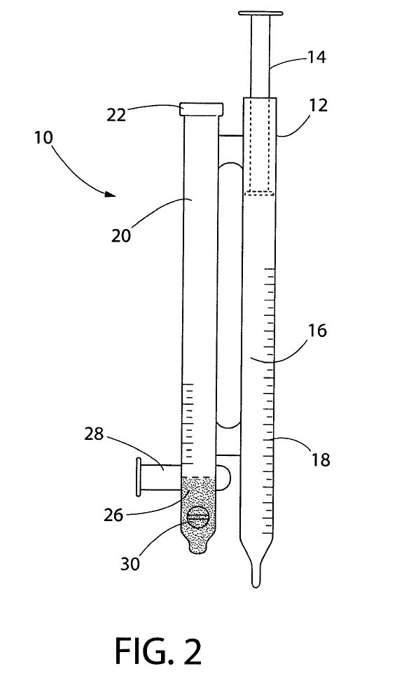

The best mode for carrying out the invention is presented in terms of its presently preferred embodiment, herein depicted within FIGS. 1 through 2. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The present invention describes a device and method for applying adhesive compound to dentures (herein described as the “device”), generally designated as 10, which provides method for applying adhesive compound to dentures.

The present invention is illustrated and described in combination with dual-tube applicator, although it will be apparent to those skilled in the relevant art that the present invention may be applied by other applicators and as such should not be interpreted as a limiting factor of the method of the present invention.

Prior to proceeding to the more detailed description of the present invention it should be noted that, for the sake of clarity and understanding, identical components, which have identical functions, have been identified with identical reference numerals throughout any views illustrated in the drawing figures.

Referring initially to FIG. 1, a flow diagram presents the preferred method of the present invention for applying adhesive compound to dentures. At step 100, the method provides applying a liquid denture adhesive to one or more locations on a denture. A liquid denture adhesive may be defined as a commercial liquid, a commercial paste or a commercial viscous gel dental adhesive. Examples of a suitable liquid denture adhesives may include Effergrip® Extra Strong Denture Adhesive Cream, Staydent® Extra Strength Denture Adhesive Cream, DentureFit® Denture Adhesive Cream, Secure® Denture Adhesive, Super Poligrip® Denture Adhesive Cream, Fixodent® Denture Adhesive Cream. The specific user may determine the best locations for applying the liquid denture adhesive for his or her denture contours and/or needs. Additionally, the user may preselect the quantity of the liquid denture adhesive based on his or her needs and/or situation. The user may apply the liquid denture adhesive in one or multiple locations on the denture. The preselected quantity of liquid denture adhesive applied to the denture may have a diameter of about ⅛ inch to about ¼ inch. In one embodiment, the diameter of the applied liquid denture adhesive may be 3/16 inch in diameter. For the purposes of the present invention, the term “about” is meant to be plus or minus five percent.

After the application of the liquid denture adhesive the method provides a step for wetting the dentures with water as seen in step 110. Next, in step 120, a powder denture adhesive is applied onto at least the liquid denture adhesive in an amount about equal to an amount of the liquid denture adhesive to form the adhesive compound on the dentures. Examples of a suitable powder denture adhesives may include Fixodent® Extra Hold Denture Adhesive Powder, Perma Grip® Denture Adhesive Powder Super Poli Grip® Extra Strength Denture Adhesive Powder. The powder denture adhesive may also be applied to areas wherein the liquid denture adhesive is not applied. The preselected quantity of powder denture adhesive applied to the denture may have a diameter of about ⅛ inch to about ¼ inch. In one embodiment, the diameter of the applied powder denture adhesive may be 3/16 inch in diameter.

The relative quantity of powder denture adhesive is determined to provide the adhesive compound in a semi-liquid form and to avoid an adhesive compound that is overly oozy, or too hard and dry. The resulting adhesive compound may be in a semi-liquid form and will be sufficient to enhance a gripping effect of the dentures in a mouth of a user. It has been found that due to the above described adhesive compound, the enhanced gripping effect increases the conventional holding time from twelve (12) hours to up to twenty-four (24) hours.

Once the adhesive compound is in place, the user may insert the denture into the proper position of the oral cavity of his or her mouth as is illustrated in Step 140.

A denture may be comprised of one denture plate or multiple denture plates.

Prior to performing the steps listed above, the user may cleanse and dry the denture.

Another embodiment of the present invention is directed to a method for applying denture adhesive with a device to enhance gripping of dentures to a user. First, the dentures are cleaned using any known technique and any known cleaner. Next, the dentures are dried. A first preselected quantity of a liquid denture adhesive may then be applied to preselected locations on the denture using the device. The user may apply the liquid denture adhesive in one or multiple locations on the denture. The preselected quantity of liquid denture adhesive applied to the denture may have a diameter of about ⅛ inch to about ¼ inch. In one embodiment, the diameter of the applied liquid denture adhesive may be 3/16 inch in diameter. After the application of the liquid denture adhesive with the device the method provides a step for wetting the dentures with water.

Next, a second preselected quantity of powder denture adhesive is applied onto the liquid denture adhesive as well as on surrounding areas of the dentures. The second preselected quantity of powder denture adhesive is about equal to the first preselected quantity of liquid denture adhesive. The preselected quantity of powder denture adhesive applied to the denture may have a diameter of about ⅛ inch to about ¼ inch. In one embodiment, the diameter of the applied powder denture adhesive may be 3/16 inch in diameter. The user may then insert the denture into the proper position of the oral cavity of his or her mouth.

It is recognized that application devices may facilitate the process. One such example is the device 10 illustrated in FIG. 2. The device 10 includes a first tube 12 and a second tube 20. The first tube 12 is provided for holding a liquid denture adhesive 16 and may include markings 18 to aid in the measurement and dispensing of the desired volume of liquid denture adhesive 16. The markings 18 may indicate any unit of measurement, for example metric markings or SI markings. Additionally, the first tube 12 may include a mechanism 14 for pushing out and applying measured amounts of liquid denture adhesive 16 onto the dentures. In one embodiment, the mechanism 14 for applying the liquid denture adhesive onto the dentures is a syringe.

The second tube 20 is provided to hold a powder denture adhesive 26. The second tube 20 includes a cap 22 for covering one end of the second tube 20. The second tube 20 may also include markings 32 to aid in measurement and dispensing of the powder. The markings 32 may indicate any unit of measurement, for example metric markings or SI markings. The second tube 20 may also include a manually operable discharge device 28, 30 operatively mounted in an opposite end of the second tube 20. The discharge device 28, 30 may be any known discharge device for example, the discharge device may be a star valve.

Another embodiment of the present invention provides for an application device for applying a denture adhesive compound to enhance gripping of dentures to a user including a first device configured to hold liquid denture adhesive and a second device configured to hold powder denture adhesive. The first device and the second device are configured to apply equal amounts of liquid denture adhesive and powder denture adhesive to preselected locations on said dentures to form the adhesive compound on the dentures in a semi-liquid form sufficient to enhance a gripping effect of the dentures in a mouth of a user. In one embodiment, the first device may comprise a first tube containing the liquid denture adhesive, markings on the first tube to aid in dispensing the liquid denture adhesive, and a mechanism for applying the liquid denture adhesive onto dentures. In one embodiment, the first device may be a syringe. In another embodiment, the first device may be a squeezable tube or any other suitable container configured to multiple portions or applications of the liquid denture adhesive. The first device may be a sealed pouch or pocket configured to hold a single application of liquid denture adhesive. The single application may be a preselected quantity.

In another embodiment, the second device may include a tube containing the powder denture adhesive, a cap covering one end of the second tube, markings on the second tube to aid in dispensing the powder denture adhesive, and a manually operable discharge device operatively mounted in an opposite end of the second tube. In a particular embodiment, the manually operable discharge device discharge device may be a star valve. In a particular embodiment the second device may be a jar or a bag configured to hold multiple portions or applications of the powder denture adhesive. In another embodiment, the second device may be a sealed pouch or pocket configured to hold a single application of powder denture adhesive. The single application may be a preselected quantity.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

Although the present invention has been shown in terms of the method of the present invention for applying adhesive compound to dentures, it will be apparent to those skilled in the art, that the present invention may be applied to other dental devices.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. A method for applying adhesive compound to dentures, comprising:
a. applying a liquid denture adhesive to one or more locations on said dentures;
b. wetting said dentures with water; and
c. applying a powder denture adhesive onto at least said liquid denture adhesive in an amount about equal to an amount of said liquid denture adhesive to form said adhesive compound on said dentures in a semi-liquid form sufficient to enhance a gripping effect of said dentures in a mouth of a user.

2. The method for applying denture adhesive of claim 1, wherein a quantity of said applied liquid denture adhesive is about ⅛ inch in diameter to about ¼ inch in diameter.

3. The method for applying denture adhesive of claim 2, wherein said quantity of said applied liquid denture adhesive is about 3/16 inch in diameter.

4. The method for applying denture adhesive of claim 1, wherein a quantity of said applied powder denture adhesive is about ⅛ inch in diameter to about ¼ inch in diameter.

5. The method for applying denture adhesive of claim 4, wherein said quantity of said applied powder denture adhesive is about 3/16 inch in diameter.

6. An application device for applying a denture adhesive compound to enhance gripping of dentures to a user, comprising:
a. a liquid denture adhesive;
b. a powder denture adhesive;
c. a first device configured to hold a quantity of said liquid denture adhesive;
d. a second device configured to hold a quantity of said powder denture adhesive; and
e. wherein said first device and said second device are configured to apply about equal amounts of liquid said denture adhesive and said powder denture adhesive to preselected locations on said dentures to form said adhesive compound on said dentures in a semi-liquid form sufficient so as to enhance a gripping effect of said dentures in a mouth of a user.

7. The application device of claim 6, wherein said first device comprises:
a. a first tube containing said liquid denture adhesive,
b. markings on said first tube to aid in dispensing said liquid denture adhesive, and
c. a mechanism for applying said liquid denture adhesive onto dentures.

8. The application device of claim 6, wherein said second device comprises:
a. a tube containing said powder denture adhesive,
b. a cap covering one end of said second tube, and
c. markings on said second tube to aid in dispensing said powder denture adhesive, and
d. a manually operable discharge device operatively mounted in an opposite end of said second tube.

9. The application device of claim 8, wherein said manually operable discharge device discharge device is a star valve.

10. The application device of claim 6, wherein said first device is a squeezable tube.

11. The application device of claim 6, wherein said first device is configured to hold a single application of said liquid denture adhesive.

12. The application device of claim 6, wherein said second device is configured to hold a single application of said powder denture adhesive.

13. In a combination with dentures, a device for applying adhesive compound comprising:
a. a liquid denture adhesive;
b. a powder denture adhesive;
c. a dual-tube applicator including:
i. a first tube containing said liquid denture adhesive,
ii. markings on said first tube to aid in dispensing said liquid denture adhesive,
iii. a mechanism for applying said liquid denture adhesive onto dentures,
iv. a second tube containing said powder denture adhesive,
v. a cap covering one end of said second tube,
vi. markings on said second tube to aid in dispensing said powder denture adhesive, and
vii. a manually operable discharge device operatively mounted in an opposite end of said second tube; and
d. whereby said device is configured to apply said liquid denture adhesive and said powder denture adhesive in an amount about equal to each other so as to form said adhesive compound in a semi-liquid form.

14. The device for applying denture adhesive to enhance gripping of dentures to a user of claim 13, wherein said mechanism is a syringe.

15. The device for applying denture adhesive to enhance gripping of dentures to a user of claim 13, wherein said manually operable discharge device is a star valve.
